(19) United States
(12) Patent Application Publication
(10) Pub. No.: US 2016/0268632 A1
(43) Pub. Date: Sep. 15, 2016

(54) IONIC LIQUID COMPRISING ALKALINE EARTH METAL

(71) Applicants: RESEARCH FOUNDATION OF THE CITY UNIVERSITY OF NEW YORK, New York, NY (US); UNIVERSITY OF PADUA, Padova (PD) (IT)

(72) Inventors: Federico Bertasi, Bardolino (VR) (IT); Chaminda Hettige, Rochester, MI (US); Steven G. Greenbaum, New York, NY (US); Michele Vittadello, Lawrenceville, NJ (US); Vito Di Noto, Cadoneghe (PD) (IT)

(21) Appl. No.: 15/032,410

(22) PCT Filed: Nov. 6, 2014
(86) PCT No.: PCT/US14/64313

§ 371 Date: Apr. 27, 2016

Related U.S. Application Data
(60) Provisional application No. 61/900,522, filed on Nov. 6, 2013.

(51) Int. Cl. H01M 10/0566; H01G 11/62; H01M 10/054

(52) U.S. Cl. CPC H01M 10/0566; H01M 10/054; H01G 11/62; H01M 2300/0045

(57) ABSTRACT

A polymer electrolyte is provided that uses an ionic liquid. The electrolyte generally has a formula of IL-(ZRₙX_{q-n})ᵥ(MYₘ)_{w}, where Z is Al, B, P, Sb, or As; R is an organic radical (alkyl, alkenyl, aryl, phenyl, benzyl, amido); X and Y are halogens (F, Cl, Br, I); M is an alkali or alkaline metal. IL is an ionic liquid that contains an organic cation (e.g. 1-alkyl-3methylimidazolium, 1-alkylpyridinium, N-methyl-N-alkylpyrrolidinium, ammonium salts) and a halide anion (F″, Cl″, Br″, or T).

### CROSS-REFERENCE TO RELATED APPLICATIONS

This application claims priority to U.S. Patent Application Ser. No. 61/900,522 (filed Nov. 6, 2013) the entirety of which is incorporated herein by reference.

### BACKGROUND OF THE INVENTION

The subject matter disclosed herein relates to electrolytes for primary and secondary energy storage devices including batteries, supercapacitors and other types of power sources.

A roadblock in route to practical Mg-based energy storage technologies is the lack of reversible electrolytes that are safe and electrochemically stable. Ethereal solutions of organometallic Mg and Mg aluminium chloride complexes are more anodically stable than those of Grignard compounds, but the resulting electrolytes are hazardous due to the volatility and flammability of the solvents.

Mg power sources are promising alternative to lithium batteries but they are far from reaching their full potential in practical applications. Existing electrolytes based on liquid solvents are inadequate for meeting the needs of functional devices in portable electronics and transportation applications. The possibility of synthesizing high-performance polymer electrolytes with MgCl₂ had been previously ruled out in the literature due to the high lattice energy of the α and β forms of this salt.

Ionic liquids (ILs) have been explored in the preparation of electrolytes for Mg batteries because, in addition to being endowed with high thermal and electrochemical stability, they exhibit negligible vapor pressure and are non-flammable. However, Mg developed a blocking passivation layer impervious to the transport of ions in the few ILs that appeared to be electrochemically stable. In addition, magnesium electrodes are generally reactive toward imidazolium-based ionic liquids. These observations dampened earlier interest in EMImCl/AlCl₃ melts partially neutralized with conventional MgCl₂.

The discussion above is merely provided for general background information and is not intended to be used as an aid in determining the scope of the claimed subject matter.

### BRIEF DESCRIPTION OF THE INVENTION

A polymer electrolyte is provided that uses an ionic liquid containing an alkaline earth metal. The electrolyte generally has a formula of IL.(ZRₙX_{q-n})ᵥ.(MYₘ)_{w}, where Z is Al, B, P, Sb, or As; R is an organic radical (alkyl, alkenyl, aryl, phenyl, benzyl, amido); X and Y are halogens (F, Cl, Br, I); M is an alkali or alkaline metal. IL is an ionic liquid that contains an organic cation (e.g. 1-alkyl-3methylimidazolium, 1-alkylpyridinium, N-methyl-N-alkylpyrrolidinium, ammonium salts) and a halide anion (F⁻, Cl⁻, Br⁻, or I⁻). An advantage that may be realized in the practice of some disclosed embodiments of the composition is that an alternative electrolyte is provided that provides alkaline earth metals as soluble, ionic liquids.

In a first embodiment, an electrolyte is provided. The electrolyte comprises an ionic liquid with a formula of IL.(ZRₙX₃₋ₙ)ᵥ.(MYₘ)_{w}, where IL is an ionic liquid that comprises a cation and a halide anion selected from the group consisting of F⁻, Cl⁻, Br⁻, and I⁻; Z is Al, B, P, Sb, or As; R is an organic radical; X and Y are independently selected from F, Cl, Br, or I; M is an alkali or alkaline metal; n is an integer that is equal to or greater than 0 and less than or equal to 3; m is 1 or 2; v is greater than 0 and less than or equal to 3 and w is greater than 0 and less than or equal to 0.5.

In a second embodiment, an energy storage device is provided. The energy storage device comprises at least one anode, at least one cathode, and at least one electrolyte comprising an ionic liquid with a formula of IL.(ZRₙX₃₋ₙ)ᵥ.(MYₘ)_{w}, where IL is an ionic liquid that comprises a cation and a halide anion selected from the group consisting of F⁻, Cl⁻, Br⁻, and I⁻; Z is Al, B, P, Sb, or As; R is an organic radical; X and Y are independently selected from F, Cl, Br, or I; M is an alkali or alkaline metal; n is an integer that is equal to or greater than 0 and less than or equal to 3; m is 1 or 2; v is greater than 0 and less than or equal to 3 and w is greater than 0 and less than or equal to 0.5

In a third embodiment, an electrolyte is provided. The electrolyte comprises an ionic liquid with a formula of [(TiCl₄)_{A}(TiCl₃)_{B}(AlCl₃)ᵥ(MYₘ)_{w} wherein A is greater than 0; B is greater than 0; v is greater than 0 and less than or equal to 3; w is greater than 0 and less than or equal to 0.5; M is an alkali or alkaline metal; Y is selected from F, Cl, Br, or I and m is 1 or 2.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts a thermal analysis of [EMIm/(AlCl₃)_{1.5}]/(δ-MgCl₂)ₓ electrolytes;

FIG. 2A depicts geometries of ionic liquid complexes as different concentrations of δ-MgCl₂;

FIG. 2B is a Raman spectra of [EMIm/(AlCl₃)_{1.5}]/(δ-MgCl₂)ₓ;

FIG. 2C is a Far infrared spectra of the [EMIm/(AlCl₃)_{1.5}]/(δ-MgCl₂)ₓ;

FIG. 2D shows Gaussian decomposition of the Raman spectra of FIG. 2B;

FIG. 2E shows Gaussian decomposition of the far IR spectrum of FIG. 2C;

FIG. 3A depicts electrical and magnetic characterization of [EMIm/(AlCl₃)_{1.5}]/(δ-MgCl₂)ₓ electrolytes using cyclic voltammograms of the ionic liquid electrolytes hosting magnesium ions, EMIm(AlCl₃)_{1.5}/(δ-MgCl₂)ₓ;

FIG. 3B depicts electrical and magnetic characterization of [EMIm/(AlCl₃)_{1.5}]/(δ-MgCl₂)ₓ electrolytes using exchange current of [EMIm/(AlCl₃)_{1.5}]/(δ-MgCl₂)ₓ;

FIG. 3C depicts electrical and magnetic characterization of [EMIm/(AlCl₃)_{1.5}]/(δ-MgCl₂)ₓ electrolytes using voltage discharge profiles of a proof of concept prototype coin cell comprised of Mg as the anode, [EMIm/(AlCl₃)_{1.5}]/(δ-MgCl₂)_{0.08} as the electrolyte, and V₂O₅ as the cathode; the inset shows the corresponding charge profiles; the rate of charge and discharge was 35 mA/g;

FIG. 3D depicts electrical and magnetic characterization of [EMIm/(AlCl₃)_{1.5}]/(δ-MgCl₂)ₓ electrolytes using real part of the conductivity surfaces obtained by broadband electrical spectroscopy of [EMIm/(AlCl₃)_{1.5}]/(δ-MgCl₂) as a function of temperature and frequency;

FIG. 3E depicts electrical and magnetic characterization of [EMIm/(AlCl₃)_{1.5}]/(δ-MgCl₂) electrolytes using temperature dependence of the ²⁵Mg NMR spectra of EMIm/(AlCl₃)_{1.5}]/(δ-MgCl₂)ₓ;

FIG. 4 shows a fractional area analysis of far infrared spectra of [EMIm/(AlCl₃)_{1.5}]/(δ-MgCl₂)ₓ electrolytes using semi-quantitative analysis of the fractional area of the far IR spectrum;

FIG. 5A shows cyclic voltammetry of [EMIm/(AlCl₃)_{1.5}]/(δ-MgCl₂)_{0.08} Electrolyte with a Pt working electrode;

FIG. 5B shows cyclic voltammetry of [EMIm/(AlCl₃)_{1.5}]/(δ-MgCl₂)_{0.08} Electrolyte with a Mg ribbon working electrode;

FIG. 6 shows temperature-dependence of direct current conductivity profiles of [EMIm/(AlCl₃)_{1.5}]/(δ-MgCl₂)ₓ electrolytes; and

FIG. 7 depicts temperature-dependence of broadband electrical parameters of [EMIm/(AlCl₃)_{1.5}]/(δ-MgCl₂)ₓ electrolytes;

### DETAILED DESCRIPTION OF THE INVENTION

Disclosed in this specification is a class of electrolytes for primary and secondary energy storage devices including batteries, supercapacitors and other types of power sources. The electrolytes disclosed herein are ionic liquids (IL) doped with a first metal salt (e.g. AlCl₃) and salts of alkali or alkaline earth metals (e.g. MgCl₂). IL can contain an organic cation (e.g. 1-alkyl-3methylimidazolium, 1-alkylpyridinium, N-methyl-N-alkylpyrrolidinium, ammonium salts) and a halide anion (F⁻, Cl⁻, Br⁻, or I⁻). The general formula for this class of electrolytes is IL.(ZRₙX_{q-n})ᵥ.(MYₘ)_{w}, where Z is Al, B, P, Sb, or As; R is an organic radical (alkyl, alkenyl, aryl, phenyl, benzyl, amido); X and Y are halogens (F, Cl, Br, I); M is an alkali or alkaline metal; n=0-3; q=3; m=1-2; v is greater than 0 and less than or equal to 3 and w is greater than 0 and less than or equal to 0.5. Other additives may be included in the mixture such as phosphorus oxides or phosphorus sulfides. The ionic liquids may be doped with, for example, AlCl3, organoalluminates, allumoxanes, and the like. In another embodiment, the ionic liquid (IL) is an inorganic compound or a mixture of inorganic compounds such as TiCl₄ and TiCl₃ (e.g. (TiCl₄)_{A}(TiCl₃)_{B}(AlCl₃)ᵥ(MYₘ)_{w} where A and B are each greater than or equal to 0). The disclosed electrolytes have a wide potential window, are non volatile, have higher chemical and thermal stabilizer, higher Coulombic efficiency, and superior electrochemical stripping and deposition characteristics.

Ionic liquids with alkaline earth metals generally suffer for solubility problems that render them unsuitable for use as electrolytes in primary (non-rechargable) and secondary (rechargeable) energy storage devices. Disclosed in this specification is a composition of matter that comprises an alkaline earth metal in an ionic liquid that is suitable for use as an electrolyte.

MgCl₂ can be prepared in a highly amorphous form of magnesium chloride called δ-MgCl₂ that is characterized by high crystallographic disorder, reactivity, and solubility. The non-conventional properties of δ-MgCl₂ are believed to be due to the presence of a metastable nanoribbon or polymeric structure with concatenating MgCl₂ repeating units, in which the Mg atoms are bridged together via chloride bridges. The preparation of polymer electrolytes using this salt has yielded Mg²⁺-conducting materials with conductivities as high as 10⁻⁴ S·cm⁻¹ at room temperature.

In one embodiment, the disclosed electrolytes are based on 1-ethyl-3-methylimidazolium chloride (EMImCl) doped with AlCl₃ and δ-MgCl₂. A phase diagram of the electrolytes revealed four thermal transitions that are strongly dependent on salt content. High-level DFT-based electronic structure calculations were undertaken to compute the structure and vibrational frequencies of the organometallic complexes, substantiating and completing assignments suggested by the experimental spectra in the far infrared region. Vibrational studies indicated the presence of two kinds of concatenated Mg-chloroaluminate complexes. Electrochemical measurements identified the redox reversibility in blocking and non-blocking conditions with an exchange current of 0.54-1.68 mA/cm² at 25° C., a Coulombic efficiency as high as 98.4%, a deposition overpotential less than 100 mV, and anodic stability of ca. 2.2 V. Broadband electric spectroscopy (BES) provided insight into the conduction mechanism in terms of dielectric and polarization phenomena. A relatively uniform Mg environment was revealed by ²⁵Mg NMR spectra. A 3D Chloride-Concatenated Dynamic structure is proposed for the Mg-conducting IL electrolytes. Mg-anode cells assembled with the electrolytes and vanadium oxide as cathode were cyclically discharged at a high rate (35 mA/g) exhibiting an initial capacity of 80 mAh/g and a steady-state voltage of 2.3 V.

ILs containing EMIm⁺ cations and various anions including: Cl⁻, BF₄⁻, and AsF₆⁻ have been thoroughly characterized using low-temperature single-crystal X-ray diffraction. These materials crystallize in layered structures with EMIm⁺ cations stacked to form one-dimensional pillars, with parallel anionic stacking (chloride) or intercalated anionic stacking (tetrafluoroborate and hexafluoroarsenate) depending on the anion size. An alternating anion and cation sequence is observed perpendicular to the direction of the pillars. The structural characteristics of these ILs are important features in understanding the ion-ion interactions within the ILs, IL-salt interactions, and the properties of the resulting electrolytes.

3D Chloride-Concatenated Dynamic Mg-ion conducting electrolytes were synthesized by permitting EMIm/(AlCl₃)_{1.5} to react with δ-MgCl₂. The resulting systems have general formula [EMIm/(AlCl₃)_{1.5}]/(δ-MgCl₂), with molar ratio x=n_{δ-MgCl}_{₂}/n_{IL}, 0≦x≦0.20, and R>1, where R=n_{AlCl}_{₃}/n_{EMImCl}. A melt is defined as basic, neutral, or acidic, if R is less, equal to, or more than 1, respectively. The mass percentage of δ-MgCl₂ may be lower than the corresponding mass percentage of salt found in a typical electrolyte used in commercial lithium batteries. Four concentrations were explored ranging from pure chloroaluminate IL (EMIm/(AlCl₃)_{1.5}) to a saturated solution of δ-MgCl₂ (Table 1). The viscosity of the samples substantially increases from liquid to paste-like characteristics.

TABLE 1
Composition of [EMIm/(AlCl₃)_{1.5}]/(δ-MgCl₂)ₓ Electrolytes.

| Sample | % wt IL | % wt δ-MgCl₂ | x = n_{δ-MgCl2}/n_{IL}^{a)} | y = n_{Mg}^{b)}/n_{AlCl3} |
|---|---|---|---|---|
| IL | 100 | 0 | 0 | — |
| 2 | 98.7 | 1.3 | 0.05 | 0.033 |
| 1 | 98.0 | 2.0 | 0.08 | 0.052 |
| 0 | 94.9 | 5.1^{c)} | 0.20 | 0.130 |

^{a)}n_{IL} is the moles of [EMImCl/(AlCl₃)_{1.5}], determined by ICP-AES spectroscopy.
^{b)}n_{Mg} is the moles of [EMImCl/(AlCl₃)_{1.5}], determined by ICP-AES spectroscopy.
^{c)}Saturated.

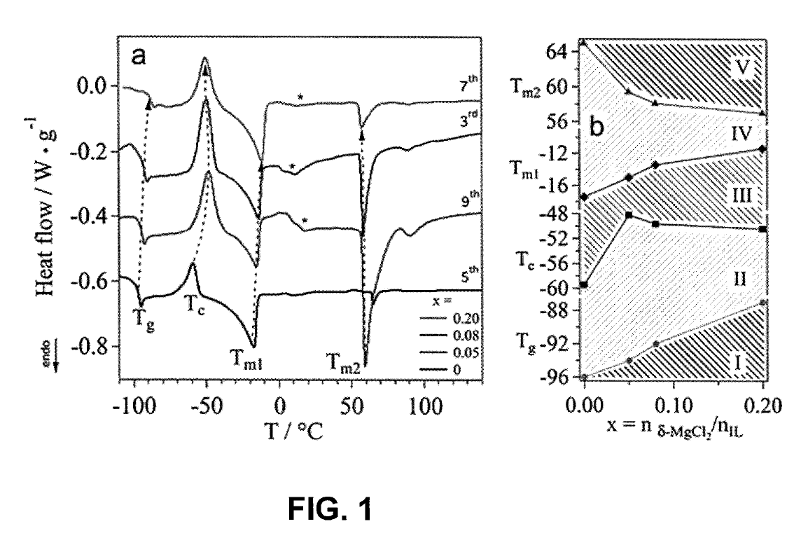

Differential scanning calorimetry (DSC) (FIG. 1) revealed that the glass transition temperatures (T_{g}) of these materials is between −100 and 90° C. due to an order-disorder event involving EMIm⁺ cations and chloroaluminate anion stacks. An exothermic crystallization (T_{c}) associated with the reorganization of EMIm⁺ cations was measured between −70 and −50° C. Two melting events, Tₘ₁ and Tₘ₂, were detected at −20 and 60° C. corresponding to A′ and B′ crystalline domains, respectively. The value of T_{g}, T_{c}, Tₘ₁, and Tₘ₂ depends on the concentration of δ-MgCl₂ modulating the relative abundance of AlCl₄⁻ and Al₂Cl₇⁻, the concentration of the Mg-chloroaluminate complexes, and the flexibility of the EMIm⁺ cationic stacks. The resulting phase diagram indicates that there are five distinct regions. Region I is a rigid phase below the glass transition temperature. In region II, at lower x values, there are two types of structures: S₁ in which the EMIm⁺ cations are packed parallel to the AlCl₄⁻ anions, both in one-dimensional pillars, and S₂ in which more sterically hindered Al₂Cl₇⁻ anions intercalate within EMIm⁺ cationic stacks. At higher concentrations, the A phase corresponds to a basic structure S₁ with anionic species consisting of MgCl₂ concatenated to AlCl₄⁻ units, while the B phase corresponds to a similar anionic complexation involving the structure S₂. In region III, at lower x, structures S₁′ and S₂′ are found in which the original one-dimensional cationic pillars reorganize to a more thermodynamically favored zig-zag stacking. The complexation of S₁′ and S₂′ by MgCl₂ at higher x, yields phases A′ and B′, respectively. In region IV at lower x values liquid S₁′ is mixed with solid S₂′, while liquid A′ is mixed with solid B′. Liquid S₁′ and A′ melt first because there is less cross-linking with AlCl₄⁻ as opposed to Al₂Cl₇⁻. In region V, the systems are completely molten.

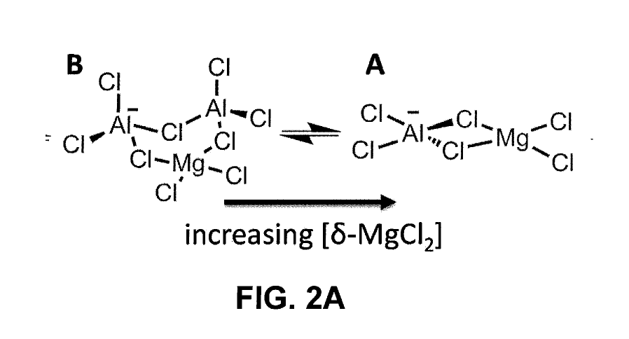

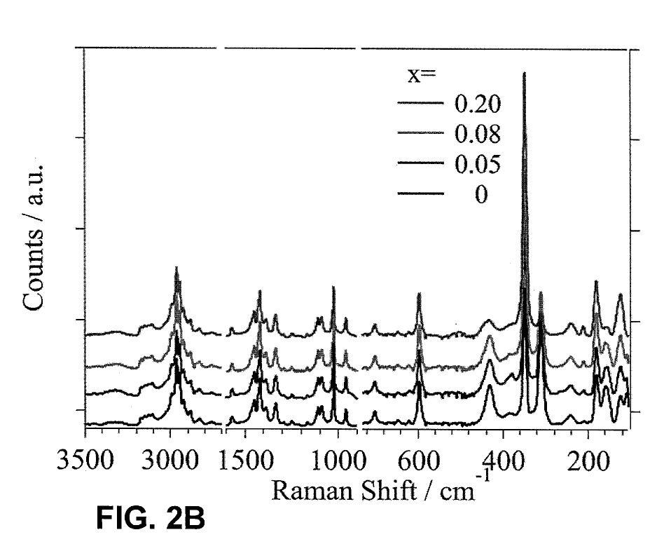

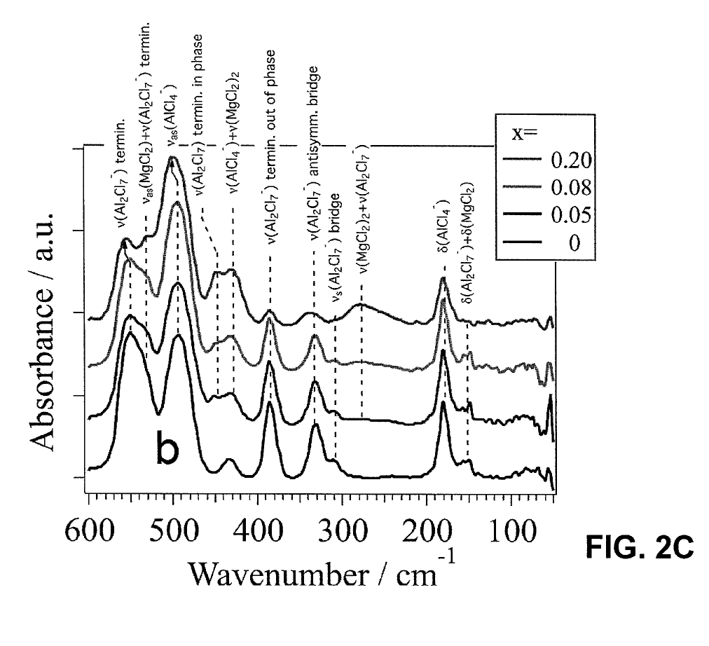

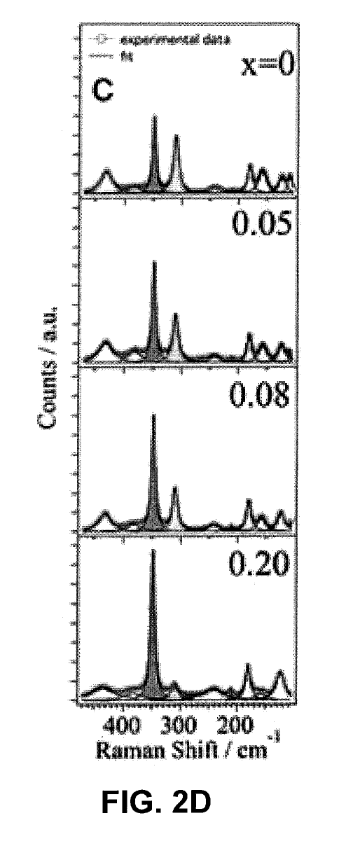

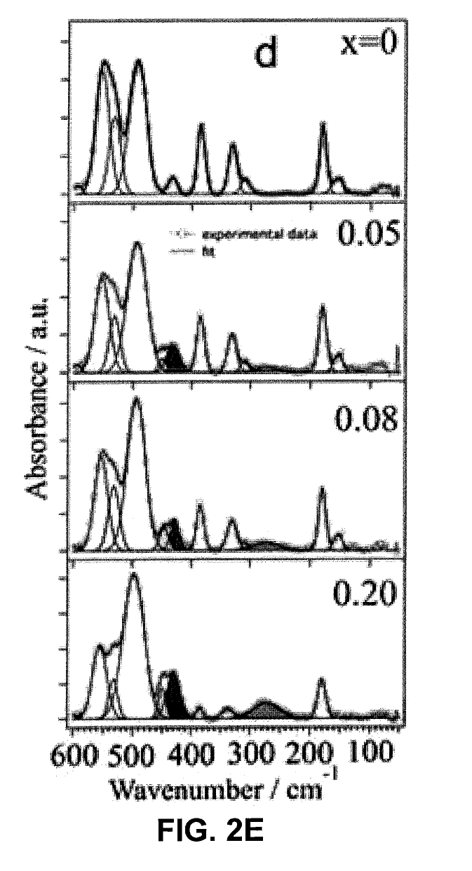

FIG. 2A depicts geometries of ionic liquid complexes as different concentrations of δ-MgCl_{2;} FIG. 2B to FIG. 2D depict vibrational spectra of [EMIm/(AlCl₃)_{1.5}]/(δ-MgCl₂)ₓ electrolytes and spectral Assignment. FIG. 2B is a Raman spectra of [EMIm/(AlCl₃)_{1.5}]/(δ-MgCl₂)ₓ with 0≦x≦0.20. FIG. 2C is a Far infrared spectra of the [EMIm/(AlCl₃)_{1.5}]/(δ-MgCl₂)ₓ with band assignment in accordance to literature and ab initio calculated vibrational modes. FIG. 2D shows Gaussian decomposition of the Raman spectra of FIG. 2B in the region between 100 and 480 cm⁻¹; the intensity of the band corresponding to the stretching of monomeric species AlCl₄⁻ (blue) increases at higher concentration of buffering Mg salt, while the intensity of the band attributed to the stretching of dimeric species Al₂Cl₇⁻ decreases. FIG. 2E shows Gaussian decomposition of the far IR spectrum of FIG. 2C; the intensities of the bands corresponding to the vibrations of polymeric MgCl₂ species and Mg—Cl—Al stretching modes increase at higher concentration of buffering Mg salt.

Experimental IR and Raman spectra of the electrolytes combined with the computed vibrational frequencies support the interpretation of the thermal data. The Raman spectra shows that the intensity of the band at 350 cm⁻¹ attributed to the stretching mode of AlCl₄⁻ increases at higher concentration of buffering Mg salt, while the intensity of the band at 311 cm⁻¹ related to the Al—Cl—Al symmetrical stretching mode of Al₂Cl₇⁻ decreases. Therefore, the concentration of AlCl₄⁻ units prevails at higher x values, as opposed to Al₂Cl₇⁻ concentrations. Frequencies derived from the ab initio calculations confirm that the presence of MgCl₂ does not affect these conclusions based on the ratio of AlCl₄⁻ and Al₂Cl₇⁻ peak intensities. Moreover, the peak intensities at 156, 310, 331, and 385 cm⁻¹ in the far IR region decrease with increasing Mg salt concentration.

As the concentration of δ-MgCl₂ increases, new peaks appear in the far IR spectrum. Also, in the IR spectra, the growth of the peak at 430 cm⁻¹ and appearance of the peak at 450 cm⁻¹ is attributed to the Mg—Cl—Al and Cl—Mg—Cl vibrational modes. It is concluded that: (a) at low Mg concentrations (x<0.05) both AlCl₄⁻ and Al₂Cl₇⁻ concatenated anionic complexes (A and B phase) dominate; (b) at higher Mg concentration (x≧0.05) the equilibrium is shifted toward the phase A chain complexes due to a decrease in the concentration of Al₂Cl₇⁻ and higher concentrations of concatenated complexes (phase A) involving Al—Cl—Mg and Cl—Mg—Cl bonding bridges.

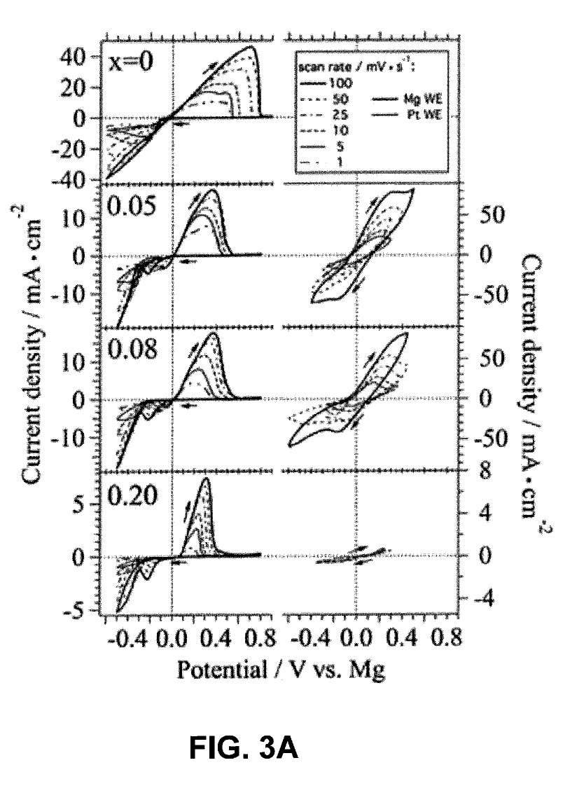

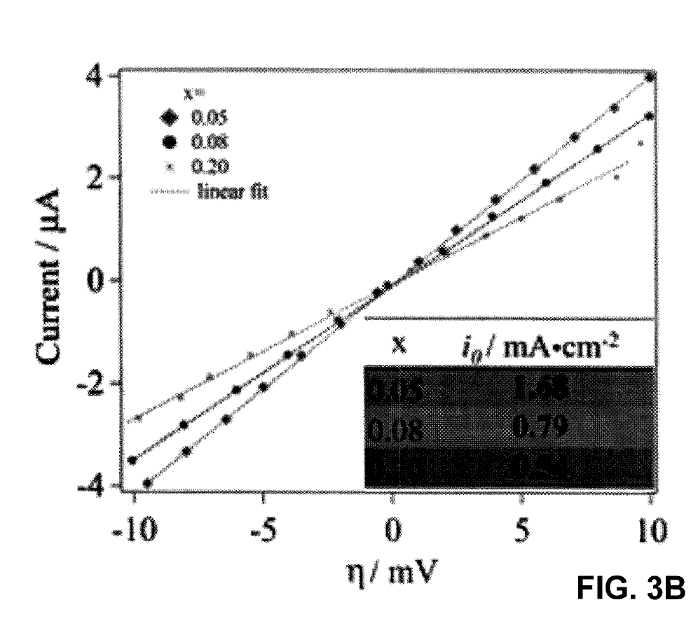

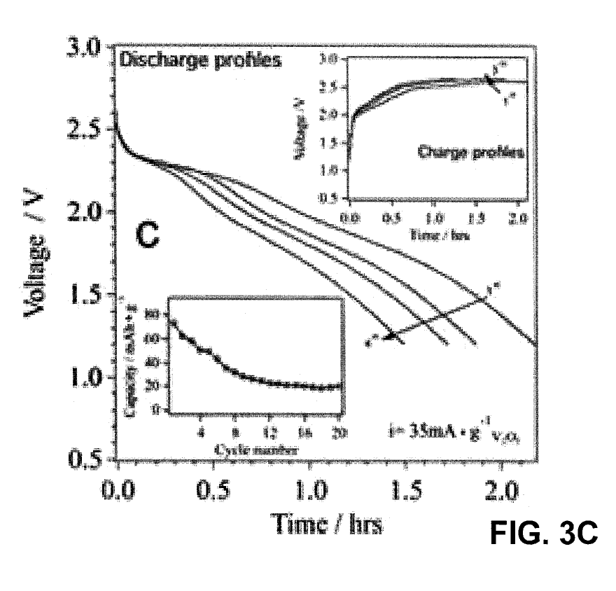

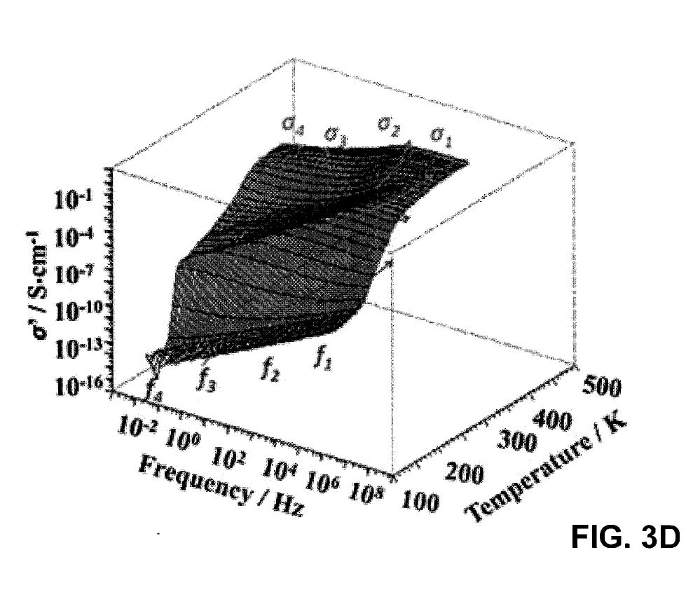

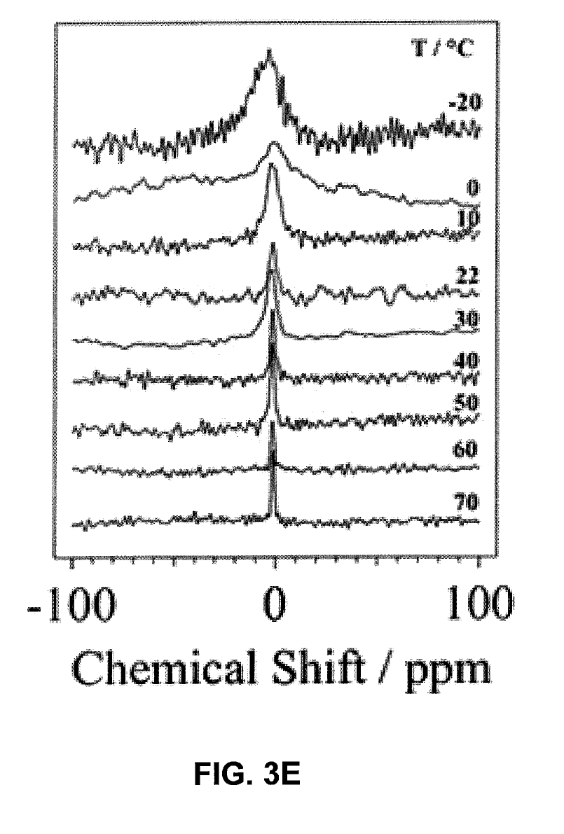

Cyclic voltammetry measurements (FIG. 3A-3E) with Pt and Mg as working electrodes indicate that the threshold potential for aluminum deposition shifts toward more negative values as the concentration of Al₂Cl₇⁻ decreases. In FIG. 3A, voltammograms on the left side were obtained with platinum working electrodes (WE) while voltammograms on the right side were obtained with magnesium as working electrode. Magnesium pseudo-reference electrodes and counter electrodes were used in all experiments, and measurements were recorded at scan rates in the range 1-100 mV/s. In the presence of Mg concatenated species, a clear cathodic peak is observed near −200 mV with a deposition overpotential lower than 100 mV. An asymmetric anodic peak is present at 400 mV which is assigned to the stripping of the co-deposited Mg—Al alloy. On average, the electrolytes show a potential window of about 2.7 V, considerably lower than the 3.9 V observed in melts buffered with conventional MgCl₂. The anodic limit (2.2 V) is due to the AlCl₄⁻ oxidation yielding Cl₂, while the cathodic stability (−0.5 V) is limited by electrolyte degradation. This demonstrates magnesium is reversibly deposited on and stripped from the anode surface in the ionic liquid electrolyte.

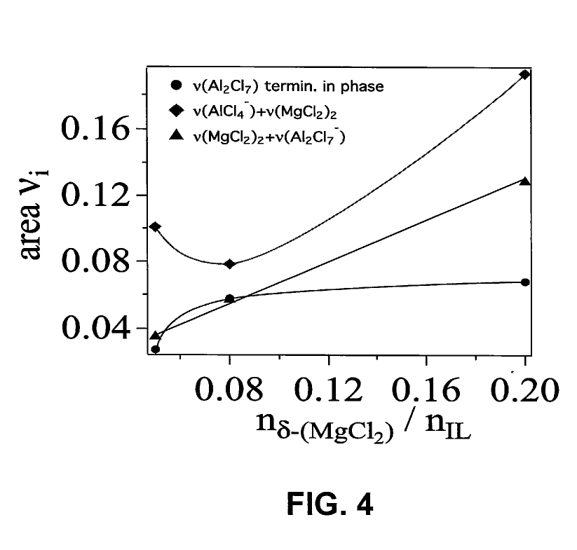

Mg deposition on Mg at 25 mV/s (FIG. 4) occurs at two distinct potentials: −100 and −200 mV, probably associated with two Mg oxidation states. Exchange currents in the interval 0.54-1.68 mA/cm² at 25° C. were observed revealing a decrease with higher Mg concentration. A proof of concept prototype coin cell was assembled using Mg as the anode, [EMIm/(AlCl₃)_{1.5}]/(δ-MgCl₂)_{0.08} as electrolyte, and V₂O₅ as the cathode. Vanadium oxide is very suitable because of its low solubility in pristine chloroaluminate ILs (≦0.05 M). Two plateaus are present in the discharge profiles at 2.3 and 1.7 V at a rate of 35 mA/g. After 10 cycles the remaining specific capacity is about 20 mAh/g. The capacity fade is attributed to a non-optimized cathode. The observed low practical specific capacity is in agreement with the literature on completely anhydrous electrolyte systems.

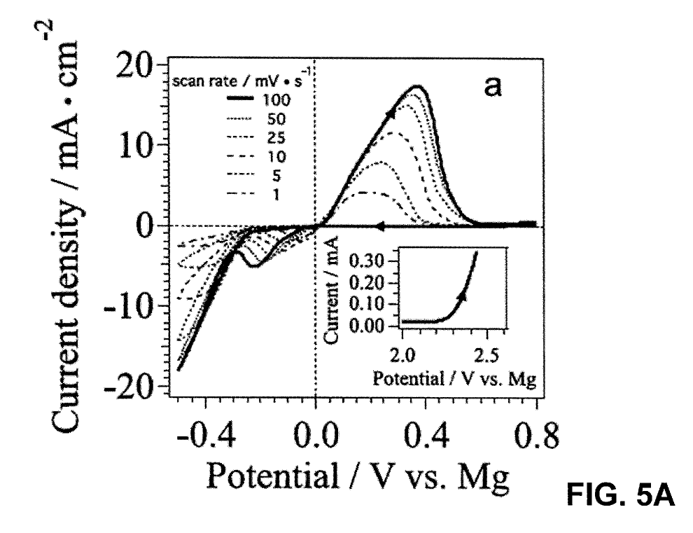

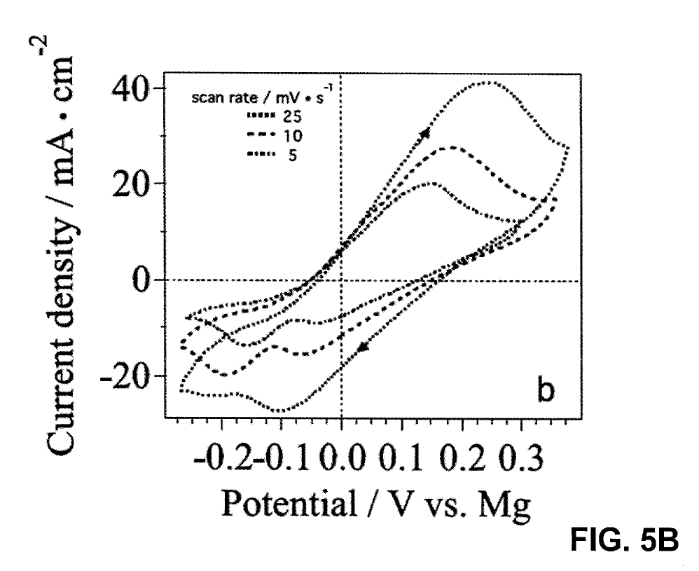

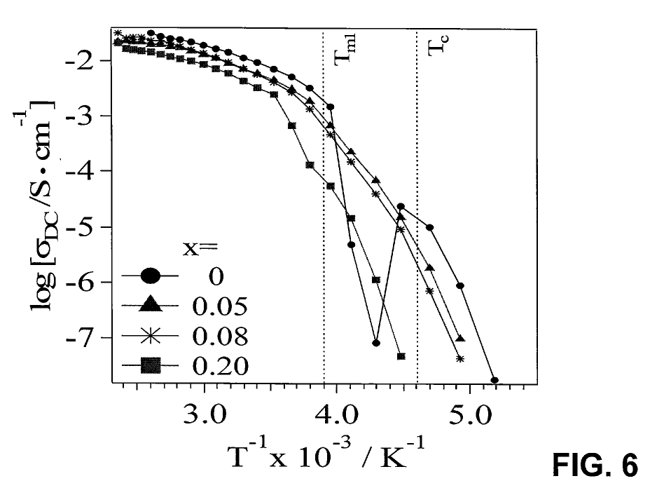

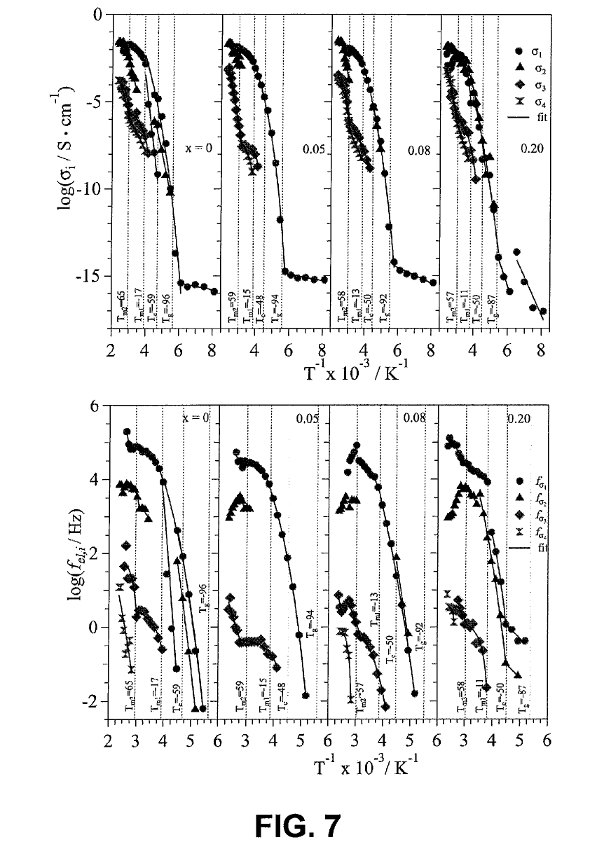

Broadband electric spectroscopy (BES) (FIG. 3C, FIG. 5A, FIG. 5B, FIG. 6, FIG. 7) was used to identify polarization (σ) and dielectric relaxations in the systems (f). The polarization events are related to the formation of cationic and anionic nanoclusters with different permittivities (εᵢ). σ₁ corresponds to the bulk conductivity of the electrolytes. It is the only polarization event below T_{g}, and exhibits Arrhenius behaviour, thus revealing a hopping mechanism with an activation energy increasing from 3.6 to 56 kJ/mol with Mg concentration. Above T_{g}, the three interdomain polarization events, σᵢ, correspond to mesoscale heterogeneities of the systems, and show a Voegel-Tamman-Fülcher (VTF) behaviour indicating that the dynamics of IL stacks assist the conduction mechanism. Without wishing to be bound to any particular theory, delocalization bodies (DBs) of different sizes, comprised of cationic aggregates, may provide the counter-charges for mostly anionic migration. Long-range migration occurs when anionic species are exchanged between different DBs, assisted by the segmental motion of micellar EMIm⁺ aggregates (f₁, f₂), and local fluctuation of the cations (f₃, f₄). Similarly broad distribution of Mg sites is detected by ²⁵Mg NMR in the electrolytes at lower temperature by the appearance of a broad resonance peak which narrows at higher temperature in proximity of Tₘ₁ due to rapid motion and site exchange, in agreement with the thermal analysis.

In summary, the fluxional nature of chlorine bridges in concatenated complexes allow for a rapid migration of Mg ions by breaking and formation of Mg—Cl (327.6 kJ/mol) and Al—Cl (511.3 kJ/mol) bonds. The concatenated anion channels delimited by micellar cationic aggregates of EMIm⁺ enable an ion pump mechanism in which Mg and Al percolate to and from the anode without disrupting the IL network and without compromising the electrochemical reversibility.

### EXPERIMENTAL

Synthesis of the IL-based electrolytes. The salt δ-MgCl₂ was prepared by reacting magnesium powder and 1-chloro butane (Sigma Aldrich) as reported in Di Noto, V., Lavina, S., Longo, D. & Vidali, M. A novel electrolytic complex based on [delta”-MgCl₂ and poly(ethylene glycol) 400. Electrochimica Acta 43, 1225-1237 (1998). The ionic liquid EMImCl(AlCl₃)_{1.5} (Io-Li-Tec USA) was vacuum dried at 105° C. for 168 hrs. δ-MgCl₂ was dissolved in EMImCl(AlCl₃)_{1.5} to saturation (6.5 w/w). Dilution with further EMImCl(AlCl₃)_{1.5} yielded the [EMIm/(AlCl₃)_{1.5}]/(δ-MgCl₂)ₓ electrolytes. All materials were stored and manipulated under Argon atmosphere.

Differential Scanning Calorimetry

DSC measurements were carried out with a MDSC 2920 instrument (TA instruments) equipped with a liquid N₂ cooling system. DSC profiles were measured from −110 to 140° C., at a heating rate of 3° C./min, by loading a weighted aliquot of sample inside a hermetically sealed aluminum pan.

Vibrational Spectroscopy

Raman spectra were recorded with a Thermo Scientific NICOLET 6700 spectrometer equipped with NXR-FT Raman spectrometer module. Samples were sealed in quartz tubes with 25,000 scans at resolution of 2 cm⁻¹. The excitation laser wavelength was 1064 nm. FT-IR Far Infrared spectra were measured using a Nicolet Nexus spectrometer with a resolution of 2 cm⁻¹ in the range 50-600 cm⁻¹. FT-FIR spectra are measured in transmission mode, loading the sample in a cell with polyethylene windows sealed inside an Argon dry-box. Each spectrum result from averaging 1000 scans.

Electrochemical Measurements

Cyclic voltammetry measurements were performed with a VSP Bio-Logic 5-channel potentiostat galvanostat. A three-electrode configuration was used at room temperature (22° C.). The working electrode was either Mg or a Pt with nominal surface area of 0.7 cm². The counter electrode and the reference electrode were both Mg. The deposition and stripping of magnesium and aluminum from the electrolyte solutions were recorded at scan rates in the range of 1-100 mV/s, until steady state was achieved. The exchange current density was determined using magnesium or platinum working electrodes by cycling the potential in a narrow potential window around zero V at 100 mV·s⁻¹. Battery cycling was conducted on coin cell prototypes comprised of Mg/{[EMImCl/(AlCl3)_{1.5}]/(δ-MgCl₂)_{0.08}}/V₂O₅ using a Maccor 2300 test station.

Broadband Electrical Spectroscopy

Measurements were conducted on a Broadband Electrical Spectrometer (BES) in the frequency range 10 mHz-10 MHz using a Novocontrol Alpha-A analyser over the temperature range −80° C.-160° C. The temperature was controlled with precision greater than +/−0.2° C. using a custom-built cryostat operating with an N₂ gas jet heating and cooling system. The sample was sandwiched between two circular platinum electrodes kept apart by a separator comprised of optical fibres (d=0.126 mm) inside a sealed cylindrical Teflon cell closed in a glove-box filled with Argon and maintained under Argon during the measurements.

NMR Measurements

The individual samples were packed into 4 mm Bruker rotors which were then hermetically sealed under Ar using Kel-F inserts and a Kel-F drive tip. The ²⁵Mg NMR spectra were obtained on a Broker 750 MHz wide-bore Ultrastabilized spectrometer at a ²⁵Mg frequency of 45.91 MHz. An aqueous solution of 11M MgCl₂ was used as an external reference and set to 0 ppm. A variable temperature study was conducted across a temperature range 253K-343K. Dry N₂ gas was employed as the carrier gas and a “90-90” Hahn-Echo pulse sequence was employed to minimize the intensity of acoustic ringing artefacts typical of low y nuclei.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electrolyte comprising an ionic liquid with a formula of IL.(ZRₙX₃₋ₙ)ᵥ.(MYₘ)_{w}, where IL is an ionic liquid that comprises a cation and a halide anion selected from a group consisting of F⁻, Cl⁻, Br⁻, and I⁻; Z is Al, B, P, Sb, or As; R is an organic radical; X and Y are independently selected from F, Cl, Br, or I; M is an alkali or alkaline metal; n is an integer that is equal to or greater than 0 and less than or equal to 3; m is 1 or 2; v is greater than 0 and less than or equal to 3 and w is greater than 0 and less than or equal to 0.5.

2. The electrolyte as recited in claim 1, wherein the cation of the ionic liquid is an 1-alkyl-3methylimidazolium ion, an 1-alkylpyridinium ion, an N-methyl-N-alkylpyrrolidinium ion, or an ammonium ion.

3. The electrolyte as recited in claim 1, wherein the electrolyte comprises a phosphorus oxide or a phosphorus sulfide.

4. The electrolyte as recited in claim 1, wherein v is greater than 1 and less than or equal to 2.

5. The electrolyte as recited in claim 1, wherein v is 1.5.

6. The electrolyte as recited in claim 1, wherein w is greater than 0.05 and less than or equal to 0.2.

7. The electrolyte as recited in claim 1, wherein v is greater than 1 and less than or equal to 2 and w is greater than 0.05 and less than or equal to 0.2.

8. The electrolyte as recited in claim 1, wherein n=0 and the formula is IL.(ZX₃)ᵥ.(δ-MgY₂)_{w}.

9. The electrolyte as recited in claim 1, wherein n=0 and the formula is IL.(AlX₃)ᵥ.(δ-MgY₂)_{w}.

10. An energy storage device comprising at least one anode, at least one cathode, and at least one electrolyte comprising an ionic liquid with a formula of IL.(ZRₙX₃₋ₙ)ᵥ.(MYₘ)_{w}, where IL is an ionic liquid that comprises a cation and a halide anion selected from a group consisting of F⁻, Cl⁻, Br⁻, and I⁻; Z is Al, B, P, Sb, or As; R is an organic radical; X and Y are independently selected from F, Cl, Br, or I; M is an alkali or alkaline metal; n is an integer that is equal to or greater than 0 and less than or equal to 3; m is 1 or 2; v is greater than 0 and less than or equal to 3 and w is greater than 0 and less than or equal to 0.5

11. The energy storage device as recited in claim 10, wherein the cation of the ionic liquid is an 1-alkyl-3methylimidazolium ion, an 1-alkylpyridinium ion, an N-methyl-N-alkylpyrrolidinium ion, or an ammonium ion.

12. The energy storage device as recited in claim 10, wherein n is 1 and R is selected from alkyl, alkenyl, aryl, phenyl, benzyl, and amido.

13. The energy storage device as recited in claim 10, wherein v is greater than 1 and less than or equal to 2.

14. The energy storage device as recited in claim 10, wherein M is an alkaline metal.

15. The energy storage device as recited in claim 10, wherein w is greater than 0.001 and less than or equal to 0.2.

16. The energy storage device as recited in claim 10, wherein w is greater than 0.05 and less than or equal to 0.5.

17. The energy storage device as recited in claim 10, wherein v is greater than 1 and less than or equal to 2 and w is greater than 0.05 and less than or equal to 0.2.

18. The energy storage device as recited in claim 10, where Z is Al, the ionic liquid is an 1-alkyl-3methylimidazolium halide, 1-alkylpyridinium halide, N-methyl-N-alkylpyrrolidinium halide, or ammonium halide.

19. The energy storage device as recited in claim 10, wherein the formula is IL.(ZRₙCl₃₋ₙ)ᵥ.(MgCl₂)_{w}.

20. An electrolyte comprising an ionic liquid with a formula of [(TiCl₄)_{A}(TiCl₃)_{B}(AlCl₃)ᵥ(MYₘ)_{w} wherein A is greater than 0; B is greater than 0; v is greater than 0 and less than or equal to 3; w is greater than 0 and less than or equal to 0.5; M is an alkali or alkaline metal; Y is selected from F, Cl, Br, or I and m is 1 or 2.
